(19) United States
(12) Patent Application Publication
(10) Pub. No.: US 2026/0276040 A1
(43) Pub. Date: Sep. 17, 2026

(54) FOIL BEARING SYSTEM WITH SELF-PRESSURIZATION AND SELF-COOLING CAPABILITIES

(71) Applicants: DALIAN UNIVERSITY OF TECHNOLOGY, Dalian (CN); BEIJING INSTITUTE OF TECHNOLOGY, Beijing (CN)

(72) Inventors: Guojun MA, Dalian (CN); Bingjin ZHANG, Dalian (CN); Xiaole GUAN, Dalian (CN); Ming GUO, Dalian (CN); Shengli XU, Dalian (CN); Chengwei WU, Dalian (CN)

(21) Appl. No.: 19/676,636

(22) Filed: May 13, 2026

(30) Foreign Application Priority Data
Nov. 17, 2025 (CN) 202511678811.1

(51) Int. Cl. F16C 37/00; F16C 17/02

(52) U.S. Cl. CPC F16C 37/00; F16C 17/024; F16C 2360/24

(57) ABSTRACT

The present invention provides a foil bearing system with self-pressurization and self-cooling capabilities, and belongs to the technical field of bearing design. The edge of each turbo impeller is provided with a plurality of flow-guide vanes, the main shaft is installed in the middle, and the positioning spacers are arranged on both ends of the main shaft; the main shaft is a stepped cylinder, and the middle part thereof is installed in conjunction with the inner wall surface of the top foil; the compliant support structure is installed between the bearing sleeve and the top foil; and the wall surfaces of the top foil and the bearing sleeve are provided with diversion holes as fluid channels. In the present invention, no external fluid supply equipment is required, which improves reliability and enables better adaptation to different working conditions and circumstances.

### TECHNICAL FIELD

The present invention belongs to the technical field of bearing design, and relates to a foil bearing system with self-pressurization and self-cooling capabilities.

### BACKGROUND

Bearings are indispensable motion support components for all rotating machinery, which play a lubricating role in reducing friction and wear while bearing external loads. Therefore, enhancing the load-carrying capacity of bearings and reducing the friction and wear of bearings are important goals in bearing design. There are numerous types of bearings with complex classifications. According to different forms of motion, the bearings can be classified into solid rolling bearings and hydrodynamic bearings. The hydrodynamic bearings can be further classified into liquid film bearings and gas bearings based on the type of lubricant. However, the working principles of the liquid film bearings and the gas bearings are to utilize hydrodynamic pressure or hydrostatic pressure to form a fluid film within the surface clearance between the journal and the bearing bush, thereby separating the journal from the bearing bush and achieving load support and lubrication.

To enhance the load-carrying capacity of hydrodynamic bearings, various solutions have been proposed. For example, a Chinese invention patent ZL202321980662.0 provides a helical groove dynamic pressure gas foil thrust bearing, having the core idea of enhancing the hydrodynamic effect of the bearing by arranging helical grooves on a flat foil, which can significantly enhance the load-carrying capacity and operational stability of the bearing. However, such design will significantly increase the manufacturing difficulty and cost, and generally has a good enhancing effect at the initial stage. As the usage time increases, wear will cause changes in the surface texture of the foil, and the enhancing effect will rapidly decline or even disappear. Other methods such as designing micro-grooves, micro-pits or special textures (for example, Chinese invention patents ZL202121488418.3, ZL202421694516.6 and ZL202421385118.6) to enhance the hydrodynamic effect also have similar problems. Hydrostatic or hydrostatic-hydrodynamic hybrid bearing (for example, a Chinese invention patent CN202411313461.4) which rely on an external system to provide fluid with a certain pressure to flow into the bearing clearance to bear part or all of the journal load can significantly enhance the load-carrying capacity of the bearings and are less affected by the revolution speed. Unfortunately, such method requires an additional power system to provide high-pressure fluid, increasing system complexity and maintenance and usage costs, and reducing system reliability.

In addition to the load-carrying capacity, the temperature rise of bearings is also a key factor related to the service life and reliability thereof. Especially when the revolution speed of the shaft is relatively high, the internal friction (viscous shear) of the lubricant or the local rub-impact effect of the friction pair will cause the temperature of the bearings to rise rapidly. If this cannot be effectively suppressed, the base material or surface coating of the bearing bush may be damaged after the temperature is too high, eventually leading to the failure of the bearings. Therefore, a Chinese invention patent ZL202110462727.1 provides a cooling structure and cooling method suitable for radial dynamic pressure foil gas bearings. By arranging axial grooves and air supply holes in the bearing pedestal and cooperating with the external shell cooling fluid inlet, a cooling passage from the shell to the inner layer of the bearing is formed. This structure effectively increases the flow area of the cooling fluid and significantly enhances the cooling effect, improving the heat dissipation adaptability and operational reliability of the bearings. However, the above method has obvious limitations, with cooling efficiency completely dependent on an additional external circulation system, which not only increases the overall complexity, space occupation and manufacturing cost of the bearing system, but also reduces the operational reliability and integration convenience of the whole device due to the need for external pumps, pipelines and fluid control units, and cannot achieve efficient and self-sufficient temperature management of the bearing body.

### SUMMARY

In view of the defects in the prior art, the present invention provides a foil bearing system with self-pressurization and self-cooling capabilities, that is, dedicated turbo impellers are arranged on both sides or one side of the bearing, matched flow guide devices, special flow channels on the bearing bush and the bearing sleeve, and a compliant support structure are designed, and lubricant with a certain pressure is forcibly introduced into the surface clearance between the bearing bush and the journal by the rotation of the main shaft, thereby significantly enhancing the load-carrying capacity of the bearing, reducing the risk of rub-impact between the journal and the bearing bush, greatly lowering the temperature rise of the bearing, and improving the overall performance of the bearing. The present invention can well overcome the problems existing in traditional bearings only by the rotation of the main shaft, without the need for an additional power system, that is, as long as the main shaft rotates and works, the foil bearing system can work therewith, significantly improving the comprehensive performance of the bearing. The present invention is particularly suitable for sliding bearings that use gas and water as working media.

To achieve the above purposes, the present invention adopts the following technical solution:

A foil bearing system with self-pressurization and self-cooling capabilities, comprising turbo impellers 1, positioning spacers 2, a main shaft 3, a compliant support structure 4, a top foil 5 and a bearing sleeve 6. Specifically:

Each turbo impeller 1 is made of a metal material and provided with a plurality of flow-guide vanes 1-1 at the edge, and when the turbo impeller 1 rotates with the main shaft, the working medium produces a directional forced flow; and the turbo impeller 1 is provided with a main shaft mounting hole 1-2 in the middle for installing the main shaft 3.

The positioning spacers 2 are integrally in an annular shape and are made of a metal material, and the positioning spacers 2 are arranged on cylinders at both ends of the main shaft and fitted with the end faces of a middle cylinder for restricting the position of the turbo impeller 1 on the main shaft 3.

The main shaft 3 is made of a metal material and is integrally an stepped cylinder, with the diameters of all sections corresponding to the inner hole diameters of assembly parts. Specifically, the main shaft 3 has a symmetrical structure, comprising the middle cylinder and the end cylinders located at both ends, and has an integrated structure, and the diameter of the end cylinders is smaller than that of the middle cylinder; and the middle cylinder is installed in conjunction with the inner wall surface of the top foil 5, and the end cylinders are installed in conjunction with the main shaft mounting holes 1-2 of the turbo impellers 1 and the positioning spacers 2.

The compliant support structure 4 is made of a metal material and is integrally a cylindrical thin shell formed by bending a rectangular foil, and after the rectangular foil is bent into the cylindrical thin shell, the boundaries of both sides do not come into contact, forming a first gap 4-1; the cylindrical thin shell is pressed into bump structures 4-2 which are alternately arranged along axial and circumferential directions, so that the contour thickness of the wall surface of the whole cylindrical thin shell is greater than the thickness of the foil; and the outer wall surface of the compliant support structure 4 is in contact with the inner wall surface of the bearing sleeve 6, the inner wall surface of the compliant support structure 4 is in contact with the outer wall surface of the top foil 5, and an elastic clearance is formed between the top foil 5 and the bearing sleeve 6 through the bump structures 4-2, which will generate an elastic reaction force by the bump structures 4-2 under the action of an external force and provide a channel for fluid flow.

The top foil 5 is made of a metal material and is integrally a cylindrical thin shell formed by bending a rectangular foil, having smooth and flat wall surfaces. When the rectangular foil is bent into shape, both sides that intersect have a partial overlap, and the overlap is bent outward at a certain angle to form inclined strip fins 5-1, which are used in conjunction with a fourth gap 6-1 of the wall surface of the bearing sleeve 6 for partially fixing the top foil 5 on the bearing sleeve 6. Both ends of the strip fins 5-1 naturally form second gaps 5-2 with the upper and lower boundaries of the cylindrical thin shell along the axis of the cylindrical thin shell, and the gap provides a certain flexible space for the deformation of the top foil 5 under load, but the width of the second gaps 5-2 should be less than that of the first gap 4-1 to cover the whole compliant support structure 4. The cylinder wall of the cylindrical thin shell is provided with a plurality of first diversion holes 5-3 as fluid channels. A plurality of third gaps 5-4 are machined on both sides or one side of the top foil 5 along the axial direction, and the third gaps 5-4 are used for bending the foil after the top foil 5 is assembled into the bearing sleeve 6, forming trumpet-shaped diversion ports 5-5, which induces high-speed fluid generated by the turbo impellers 1 to enter a clearance between the top foil 5 and the main shaft 3, generating hydrostatic pressure and cooling effect.

The bearing sleeve 6 is made of a metal material and is integrally cylindrical, and the inner wall surface is provided with a fourth gap 6-1 forming a certain angle with the radius direction, which is used for inserting the strip fins 5-1 of the top foil 5 for use in conjunction for partially fixing the top foil 5 on the bearing sleeve 6; the fourth gap 6-1 is axially penetrating, but cannot penetrate the wall surface of the bearing sleeve 6 in the depth direction; and a plurality of second diversion holes 6-2 are machined on the wall surface of one side of the fourth gap 6-1 of the bearing sleeve 6 as fluid channels.

Further, the first diversion holes 5-3 and the second gaps 5-2 of the top foil 5 are opposite in position, that is, differing by approximately 180° along the circumferential direction.

Further, the third gaps 5-4 are machined on both sides or one side of the top foil 5; if machined on both sides, the third gaps 5-4 are symmetrically arranged at both ends, the length of the gaps on one side is equal to half the difference between the axial length of the top foil 5 and the axial length of the bearing sleeve 6; and if only machined on one side, the length of the gaps is equal to the difference between the axial length of the top foil 5 and the axial length of the bearing sleeve 6.

Further, one or two turbo impellers 1 are provided, and one or two positioning spacers 2 matched with the turbo impellers 1 are provided. In case that one turbo impeller 1 is provided: when the rotation of the turbo impeller 1 causes fluid to flow towards a clearance between the top foil 5 and the main shaft 3 in the middle, that is, the fluid flows towards the foil bearing in the middle, the foil bearing system is a single-sided blow-in foil bearing system with self-pressurization and self-cooling capabilities; and when the rotation of the turbo impeller 1 causes fluid to flow away from the foil bearing in the middle, the foil bearing system is a single-side suction-type foil bearing system with self-pressurization and self-cooling capabilities. In case that two turbo impellers 1 are provided: when the rotation of the turbo impellers 1 on both sides causes fluid to flow towards the foil bearing in the middle, the foil bearing system is a double-sided blow-in foil bearing system with self-pressurization and self-cooling capabilities; when the rotation of the turbo impellers 1 on both sides causes fluid to flow away from the foil bearing in the middle, the foil bearing system is a double-sided suction-type foil bearing system with self-pressurization and self-cooling capabilities; and when the rotation of the turbo impeller 1 on one side causes fluid to flow towards the foil bearing in the middle, and the rotation of the turbo impeller 1 on the other side causes fluid to flow away from the foil bearing in the middle, the foil bearing system is a double-sided blow-and-suck foil bearing system with self-pressurization and self-cooling capabilities. The turbo impellers 1 are installed by interference fit with the end cylinders of the main shaft 3.

A usage method for a foil bearing system with self-pressurization and self-cooling capabilities, comprises the following steps:
Step 1: placing the compliant support structure 4 into the bearing sleeve 6, and aligning the position of the first gap 4-1 with that of the fourth gap 6-1 so that the compliant support structure 4 is aligned with both ends of the bearing sleeve 6; and then placing the top foil 5 on the inner side of the compliant support structure 4, aligning the second gaps 5-2 with the first gap 4-1, inserting the strip fins 5-1 into the fourth gap 6-1, adjusting the axial relative positions of the compliant support structure 4, the top foil 5 and the bearing sleeve 6 so that the roots of the third gaps 5-4 are exactly located at the outer edge of the end of the bearing sleeve 6, and bending the top foil 5 outward along the third gaps 5-4 to form trumpet-shaped diversion ports 5-5, thus completing the installation of the foil hydrodynamic bearing and obtaining the foil hydrodynamic bearing.
Step 2: inserting one positioning spacer 2 and turbo impeller 1 from one side of the main shaft 3, wherein the positioning spacer 2 and the main shaft 3 are in transition fit, and the turbo impeller 1 and the main shaft 3 are in interference fit.
Step 3: inserting the foil hydrodynamic bearing installed in step 1 from the other side of the main shaft 3, and installing the foil hydrodynamic bearing on the main shaft 3, wherein the top foil 5 and the main shaft 3 are in slight interference fit; if the turbo impeller is provided on one side, the whole installation process is completed; and if the turbo impellers are provided on both sides, proceeding to step 4.
Step 4: inserting the other positioning spacer 2 and turbo impeller 1 from the other side of the main shaft 3, wherein the positioning spacer 2 and the main shaft 3 are in transition fit, and the turbo impeller 1 and the main shaft 3 are in interference fit, thus completing the installation of the whole foil bearing system with self-pressurization and self-cooling capabilities.

In specific mechanical systems, the above steps can be adjusted according to the actual situation.

In use, the turbo impellers 1 will rotate with the main shaft, so as to drive the working medium to flow towards or away from the foil bearing in the middle. The effect on the bearing will be related to the installation and arrangement method, which is classified into the following five situations:
(1) Double-sided blow-in: two turbo impellers 1 are symmetrically arranged on both sides of the foil hydrodynamic bearing, and the rotation of the two turbo impellers 1 causes fluid to flow simultaneously towards a clearance between the top foil 5 and the main shaft 3 in the middle, that is, flowing simultaneously towards the foil bearing in the middle. At this moment, high-speed fluid will simultaneously enter the clearance between the top foil 5 and the main shaft 3 under the guidance of the diversion ports 5-5 formed by the top foil 5 at both ends of the bearing and then flow out of the foil hydrodynamic bearing successively through the first diversion holes 5-3, the clearance between the top foil 5 and the bearing sleeve 6 and the second diversion holes 6-2. The hydrostatic pressure generated and the hydrodynamic pressure generated by the bearing due to rotation act together, the main shaft 3 is supported, the compliant support structure 4 is compressed and deformed, and the clearance between the top foil 5 and the main shaft 3 increases accordingly, which enhances the load-carrying capacity, lowers the lift-off speed and reduces the risk of rub-impact between the main shaft 3 and the top foil 5. Moreover, the working heat flow of the foil hydrodynamic bearing can be carried away, and the working temperature of the bearing can be reduced. Theoretically, the axial load caused by the two turbo impellers 1 can also be self-balanced, achieving multiple purposes at once.
(2) Double-sided blow-and-suck: two turbo impellers 1 are antisymmetrically arranged on both sides of the foil hydrodynamic bearing, the rotation of the turbo impeller 1 on one side will cause fluid to flow towards the foil bearing in the middle, and the rotation of the turbo impeller 1 on the other side will cause fluid to flow away from the foil bearing in the middle. At this moment, the first diversion holes 5-3 and the second diversion holes 6-2 may not be provided, the top foil 5 only needs to be provided with third gaps 5-4 and diversion ports 5-5 on one side facing the fluid, and high-speed fluid enters the clearance between the top foil 5 and the main shaft 3 directly through the diversion ports 5-5 and then flows out directly from the other end, which can also generate a strong hydrostatic pressure and hydrodynamic pressure and effectively carry away heat. Compared with (1), such arrangement will significantly simplify the structure, but the hydrostatic pressure will be slightly weak, and a large unbalanced force will be generated in the axial direction, which needs to be taken into consideration in the overall design.
(3) Double-sided suction-type: two turbo impellers 1 are symmetrically arranged on both sides of the foil hydrodynamic bearing, but the rotation of the two turbo impellers 1 causes fluid to simultaneously flow away from the bearing in the middle, that is, the turbo impellers 1 on both sides of the bearing will simultaneously generate a suction effect. At this moment, the fluid will flow into the clearance between the top foil 5 and the bearing sleeve 6 through the second diversion holes 6-2, then enter the clearance between the top foil 5 and the main shaft 3 through the first diversion holes 5-3 and finally flow out from both ends of the bearing. This process will generate a significant hydrostatic pressure, which couples with the hydrodynamic pressure generated by the rotation of the main shaft. The effect is generally similar to that in (1), and the third gaps 5-4 and the diversion ports 5-5 on the top foil 5 may not be provided, simplifying the structure and assembly process. However, the fluid flowing through the clearance between the top foil 5 and the bearing sleeve 6 may cause the top foil 5 to deform towards the main shaft 3, increasing the risk of rub-impact, which needs to be comprehensively considered.
(4) Single-sided blow-in: one turbo impeller 1 is arranged on one side of the foil hydrodynamic bearing, fluid flows towards the foil bearing in the middle, and no turbo impeller is arranged on the other side. At this moment, the first diversion holes 5-3 and the second diversion holes 6-2 may not be provided, the top foil 5 only needs to be provided with third gaps 5-4 and diversion ports 5-5 on one side close to the turbo impeller 1, and high-speed fluid enters the clearance between the top foil 5 and the main shaft 3 through the diversion ports 5-5 and then flows out directly from the other end, which can also generate a certain hydrostatic pressure and hydrodynamic pressure and effectively carry away heat. Compared with (2), the hydrostatic pressure will be weakened, but the structure will be further simplified, and the axial unbalanced force will also be smaller.
(5) Single-side suction-type: one turbo impeller 1 is arranged on one side of the foil hydrodynamic bearing, fluid flows away from the bearing, and no turbo impeller is arranged on the other side. At this moment, the first diversion holes 5-3 and the second diversion holes 6-2 may not be provided, the top foil 5 only needs to be provided with third gaps 5-4 and diversion ports 5-5 on one side without the turbo impeller 1, and the fluid will enter the clearance between the top foil 5 and the main shaft 3 through the diversion ports 5-5 due to the entrainment effect of the turbo impeller 1 on the other side and then flow out directly from the other end close to the turbo impeller 1. The performance and structure characteristics are basically similar to those in (4).

Compared with the prior art, the present invention has the following beneficial effects:
(1) In the present invention, with the arrangement of the turbo impellers on both sides or one side of the foil hydrodynamic bearing, the working medium produces a forced flow with the rotation of the main shaft, which increases the hydrostatic pressure and convective heat transfer effect, significantly enhances the load-carrying capacity of the bearing, lowers the lift-off speed of the bearing, reduces the risk of rub-impact between the bearing bush and the journal surface as well as the operating temperature, improves the reliability and service life of the bearing, and greatly improves the overall performance of the bearing.
(2) The present invention does not require external fluid supply equipment, works synchronously with the main shaft, and has good self-adaptive characteristics, reducing system complexity and cost, and improving system reliability.
(3) In the present invention, the machining and installation difficulty of the components is not increased significantly compared with that of conventional bearings, and the components can be flexibly arranged, replaced or reused, which is conducive to controlling the cost and difficulty of usage and maintenance and also enables better adaptation to different working conditions and circumstances.

### DESCRIPTION OF DRAWINGS

FIG. 1 is a structural exploded schematic diagram of the present invention;

FIG. 2 is a structural schematic diagram of a turbo impeller;

FIG. 3 is a structural schematic diagram of a compliant support structure;

FIG. 4 is a structural schematic diagram of a top foil;

FIG. 5 is a structural schematic diagram of a bearing sleeve;

FIG. 6 is a schematic diagram of a double-sided blow-in foil bearing system with self-pressurization and self-cooling capabilities;

FIG. 7 is a sectional view of a double-sided blow-in foil bearing system with self-pressurization and self-cooling capabilities;

FIG. 8 is a schematic diagram of a single-sided blow-in foil bearing system with self-pressurization and self-cooling capabilities;

In the figures: 1 turbo impeller; 2 positioning spacer; 3 main shaft; 4 compliant support structure; 5 top foil; 6 bearing sleeve; 1-1 flow-guide vane; 1-2 main shaft mounting hole; 4-1 first gap; 4-2 bump structure; 5-1 strip fin; 5-2 second gap; 5-3 first diversion hole; 5-4 third gap; 5-5 diversion port; 6-1 fourth gap; 6-2 second diversion hole.

### DETAILED DESCRIPTION

To make the purpose, the technical solution and advantages of the embodiments of the present invention more clear, the technical solution in the embodiments of the present invention will be clearly and fully described below in combination with the drawings in the embodiments of the present invention.

### Embodiment 1

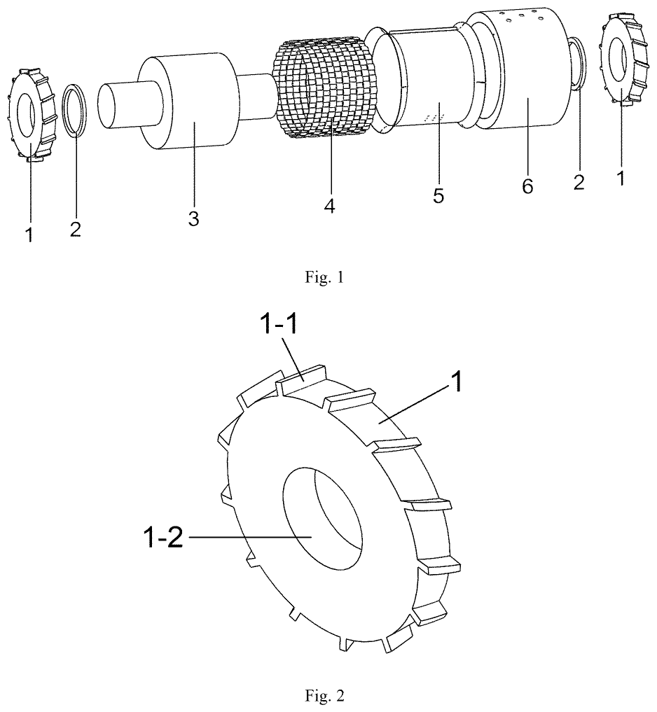

The present embodiment is provided with two turbo impellers 1, and provides a double-sided blow-in foil bearing system with self-pressurization and self-cooling capabilities, with the specific structure shown in FIG. 1 to FIG. 7 and the exploded diagram shown in FIG. 1, comprising two turbo impellers 1, two positioning spacers 2, a main shaft 3, a compliant support structure 4, a top foil 5 and a bearing sleeve 6. Specifically:

Each turbo impeller 1 is made of a metal material and made of 6061-T6 aluminum alloy in the present embodiment; the turbo impeller 1 has an overall shape shown in FIG. 2 and is provided with a plurality of flow-guide vanes 1-1 at the edge, the number of the vanes in the present embodiment is 13, and when the turbo impeller 1 rotates with the main shaft 3, the working medium produces a directional forced flow; and the turbo impeller 1 is provided with a main shaft mounting hole 1-2 in the middle for installing the main shaft 3.

Each positioning spacer 2 is made of a metal material and made of 304 stainless steel in the present embodiment; and the positioning spacer 2 is integrally in an annular shape for restricting the relative position of the turbo impeller 1 on the main shaft 3.

The main shaft 3 is made of a metal material and made of 40Cr steel in the present embodiment; and the main shaft 3 is integrally an stepped cylinder, with the diameters of all sections corresponding to the inner hole diameters of assembly parts. Specifically, the main shaft 3 has a symmetrical structure, comprising a middle cylinder and two end cylinders located at both ends, and has an integrated structure, and the diameter of the end cylinders is smaller than that of the middle cylinder; and the middle cylinder is installed in conjunction with the inner wall surface of the top foil 5, and the two end cylinders are installed in conjunction with the main shaft mounting holes 1-2 of the turbo impellers 1.

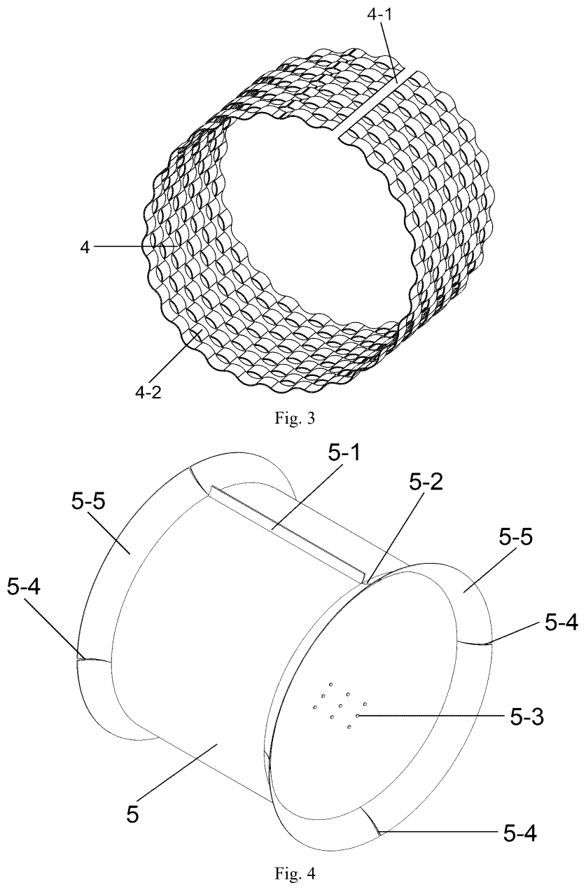

The compliant support structure 4 is made of a metal material and made of GH4145 alloy in the present embodiment; the compliant support structure 4 has an overall shape shown in FIG. 3 and is a cylindrical thin shell formed by bending a rectangular foil, and the boundaries of both sides do not come into contact, forming a first gap 4-1; the thin shell is pressed into bump structures 4-2 which are alternately arranged along axial and circumferential directions, so that the contour thickness of the wall surface of the whole thin shell is greater than the thickness of the foil; and the outer wall surface of the compliant support structure 4 is in contact with the inner wall surface of the bearing sleeve 6, the inner wall surface of the compliant support structure 4 is in contact with the outer wall surface of the top foil 5, and an elastic clearance is formed between the top foil 5 and the bearing sleeve 6 through the bump structures 4-2, which will generate an elastic reaction force by the bump structures 4-2 under the action of an external force and provide a channel for fluid flow.

The top foil 5 is made of a metal material and made of GH4145 alloy in the present embodiment; the top foil 5 is integrally a cylindrical thin shell formed by bending a rectangular foil, as shown in FIG. 4, having smooth and flat wall surfaces; when the rectangular foil is bent into shape, both sides have a partial overlap, and the overlap is bent outward at a certain angle to form inclined strip fins 5-1, which are used in conjunction with a fourth gap 6-1 of the wall surface of the bearing sleeve 6 for partially fixing the top foil 5 on the bearing sleeve 6; the strip fins 5-1 form second gaps 5-2 with the boundary of the other side, which have a width less than the first gap 4-1, and in the present embodiment, the width of the second gaps 5-2 is 0.2 mm, and the width of the first gap 4-1 is 0.3 mm; the foil on one side of the second gaps 5-2 is provided with nine first diversion holes 5-3 near the middle position of the wall surface at a 180° circumferential position from the second gaps 5-2 of the top foil 5 as fluid channels; eight third gaps 5-4 are machined on both sides of the top foil 5 along the axial direction and symmetrically arranged at both ends, and the length of the gaps on one side is equal to half the difference between the axial length of the top foil 5 and the axial length of the bearing sleeve 6; and the third gaps 5-4 are used for bending the foil after the top foil 5 is assembled into the bearing sleeve 6, forming trumpet-shaped diversion ports 5-5, which induces high-speed fluid generated by the turbo impellers 1 to enter the clearance between the top foil 5 and the main shaft 3, generating hydrostatic pressure and cooling effect.

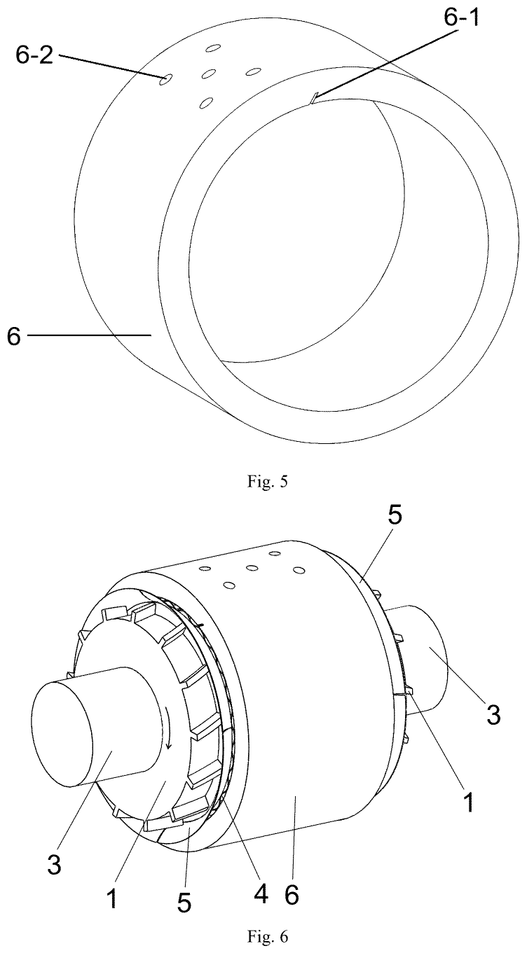

The bearing sleeve 6 is made of a metal material and made of 304 stainless steel in the present embodiment; the bearing sleeve 6 is integrally cylindrical, as shown in FIG. 5, and the inner wall surface is provided with a fourth gap 6-1 forming an angle of 130° with the radius direction, which is used in conjunction with the strip fins 5-1 of the top foil 5 for partially fixing the top foil 5 on the bearing sleeve 6; the fourth gap 6-1 is axially penetrating, but does not penetrate the wall surface of the bearing sleeve 6 in the depth direction; and five second diversion holes 6-2 are machined on the wall surface of one side of the fourth gap 6-1 of the bearing sleeve 6 as fluid channels.

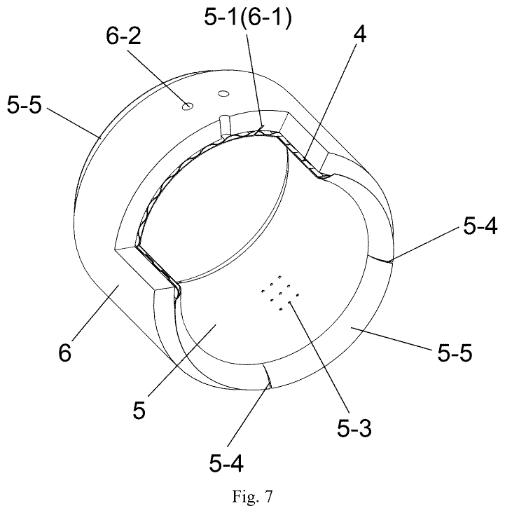

An installation method for a double-sided blow-in foil bearing system with self-pressurization and self-cooling capabilities, comprises the following steps:
S1: Placing the compliant support structure 4 into the bearing sleeve 6, and aligning the position of the first gap 4-1 with that of the fourth gap 6-1 so that the compliant support structure 4 is aligned with both ends of the bearing sleeve 6; and then placing the top foil 5 on the inner side of the compliant support structure 4, aligning the second gaps 5-2 with the first gap 4-1, inserting the strip fins 5-1 into the fourth gap 6-1, adjusting the axial relative positions of the compliant support structure 4, the top foil 5 and the bearing sleeve 6 so that the roots of the third gaps 5-4 are exactly located at the outer edge of the end of the bearing sleeve 6, and bending the top foil 5 outward along the third gaps 5-4 to form trumpet-shaped diversion ports, thus completing the installation of the foil hydrodynamic bearing and obtaining the foil hydrodynamic bearing.
S2: Successively inserting one positioning spacer 2 and turbo impeller 1 from one side of the main shaft 3, wherein the positioning spacer 2 and the main shaft 3 are in transition fit, and the turbo impeller 1 and the main shaft 3 are in interference fit.
S3: Inserting the foil hydrodynamic bearing installed in S1 from the other side of the main shaft 3, and installing the foil hydrodynamic bearing on the main shaft 3, wherein the top foil 5 and the main shaft 3 are in slight interference fit.
S4: Inserting the other positioning spacer 2 and turbo impeller 1 from the other side of the main shaft 3, wherein the positioning spacer 2 and the main shaft 3 are in transition fit, and the turbo impeller 1 and the main shaft 3 are in interference fit, thus completing the installation of the whole double-sided blow-in foil bearing system with self-pressurization and self-cooling capabilities and obtaining the schematic diagram of the double-sided blow-in foil bearing system with self-pressurization and self-cooling capabilities shown in FIG. 6, with the sectional view shown in FIG. 7.

A usage method for a double-sided blow-in foil bearing system with self-pressurization and self-cooling capabilities, comprises the following steps:

Two turbo impellers 1 are symmetrically arranged on both sides of the foil hydrodynamic bearing, and high-speed fluid generated flows towards the bearing in the middle from both ends, that is, the high-speed fluid will enter the clearance between the top foil 5 and the main shaft 3 under the guidance of the trumpet-shaped diversion ports 5-5 formed by the top foil 5 at both ends of the bearing and then flow out of the bearing through the first diversion holes 5-3, the clearance between the top foil 5 and the bearing sleeve 6 and the second diversion holes 6-2. The hydrostatic pressure generated and the hydrodynamic pressure generated by the bearing due to rotation act together, the main shaft 3 is supported, the compliant support structure 4 is compressed and deformed, and the clearance between the top foil 5 and the main shaft 3 increases accordingly, which enhances the load-carrying capacity and reduces the risk of rub-impact between the main shaft 3 and the top foil 5. Moreover, the working heat flow of the bearing is carried away, finally improving the comprehensive performance of the bearing.

### Embodiment 2

The present embodiment is provided with one turbo impeller 1, and provides a single-sided blow-in foil bearing system with self-pressurization and self-cooling capabilities, with the specific structure shown in FIG. 1 to FIG. 5 and FIG. 8, comprising a turbo impeller 1, a positioning spacer 2, a main shaft 3, a compliant support structure 4, a top foil 5 and a bearing sleeve 6. Specifically:

Each turbo impeller 1 is made of a metal material and made of 6061-T6 aluminum alloy in the present embodiment; the turbo impeller 1 has an overall shape shown in FIG. 2 and is provided with a plurality of flow-guide vanes 1-1 at the edge, the number of the vanes in the present embodiment is 13, and when the turbo impeller 1 rotates with the main shaft 3, the working medium will produce a directional forced flow; and the turbo impeller 1 is provided with a main shaft mounting hole 1-2 in the middle for installing the main shaft 3.

Each positioning spacer 2 is made of a metal material and made of 304 stainless steel in the present embodiment; and the positioning spacer 2 is integrally in an annular shape for restricting the relative position of the turbo impeller 1 on the main shaft 3.

The main shaft 3 is made of a metal material and made of 40Cr steel in the present embodiment; and the main shaft 3 is integrally an stepped cylinder, with the diameters of all sections corresponding to the inner hole diameters of assembly parts. Specifically, the main shaft 3 has a symmetrical structure, comprising a middle cylinder and two end cylinders located at both ends, and has an integrated structure, and the diameter of the end cylinders is smaller than that of the middle cylinder; and the middle cylinder is installed in conjunction with the inner wall surface of the top foil 5, and the two end cylinders are installed in conjunction with the main shaft mounting holes 1-2 of the turbo impellers 1.

The compliant support structure 4 is made of a metal material and made of GH4145 alloy in the present embodiment; the compliant support structure 4 has an overall shape shown in FIG. 3 and is a cylindrical thin shell formed by bending a rectangular foil, and the boundaries of both sides do not come into contact, forming a first gap 4-1; the thin shell is pressed into bump structures 4-2 which are alternately arranged along axial and circumferential directions, so that the contour thickness of the wall surface of the whole thin shell is greater than the thickness of the foil; and the outer wall surface of the compliant support structure 4 is in contact with the inner wall surface of the bearing sleeve 6, the inner wall surface of the compliant support structure 4 is in contact with the outer wall surface of the top foil 5, and an elastic clearance will be formed between the top foil 5 and the bearing sleeve 6 through the bump structures 4-2, which will generate an elastic reaction force by the bump structures 4-2 under the action of an external force and provide a channel for fluid flow.

The top foil 5 is made of a metal material and made of GH4145 alloy in the present embodiment; the top foil 5 is integrally a cylindrical thin shell formed by bending a rectangular foil, as shown in FIG. 4, having smooth and flat wall surfaces; when the rectangular foil is bent into shape, both sides have a partial overlap, and the overlap is bent outward at a certain angle to form inclined strip fins 5-1, which are used in conjunction with a fourth gap 6-1 of the wall surface of the bearing sleeve 6 for partially fixing the top foil 5 on the bearing sleeve 6; the strip fins 5-1 form second gaps 5-2 with the boundary of the other side, which have a width less than the first gap 4-1, and in the present embodiment, the width of the second gaps 5-2 is 0.2 mm, and the width of the first gap 4-1 is 0.3 mm; in the present embodiment, it is not necessary to arrange the first diversion holes 5-3 shown in FIG. 4; four third gaps 5-4 are machined on one side of the top foil 5 along the axial direction, and the length of the gaps is equal to the difference between the axial length of the top foil 5 and the axial length of the bearing sleeve 6; and the third gaps 5-4 are used for bending the foil after the top foil 5 is assembled into the bearing sleeve 6, forming trumpet-shaped diversion ports 5-5, which induces high-speed fluid generated by the turbo impellers 1 to enter the clearance between the top foil 5 and the main shaft 3, generating hydrostatic pressure and cooling effect.

The bearing sleeve 6 is made of a metal material and made of 304 stainless steel in the present embodiment; the bearing sleeve 6 is integrally cylindrical, as shown in FIG. 5, and the inner wall surface is provided with a fourth gap 6-1 forming an angle of 130° with the radius direction, which is used in conjunction with the strip fins 5-1 of the top foil 5 for partially fixing the top foil 5 on the bearing sleeve 6; the fourth gap 6-1 is axially penetrating, but does not penetrate the wall surface of the bearing sleeve 6 in the depth direction; and in the present embodiment, it is not necessary to arrange the second diversion holes 6-2 shown in FIG. 5.

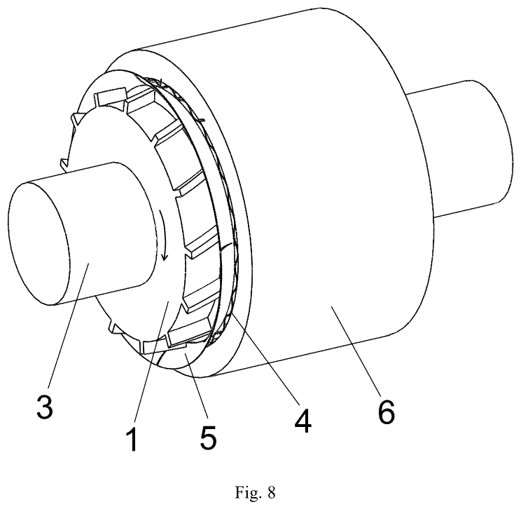

A single-sided blow-in foil bearing system with self-pressurization and self-cooling capabilities is installed as follows:
S1: Placing the compliant support structure 4 into the bearing sleeve 6, and aligning the position of the first gap 4-1 with that of the fourth gap 6-1 so that the compliant support structure 4 is aligned with both ends of the bearing sleeve 6; and then placing the top foil 5 on the inner side of the compliant support structure 4, aligning the second gaps 5-2 with the first gap 4-1, inserting the strip fins 5-1 into the fourth gap 6-1, adjusting the axial relative positions of the compliant support structure 4, the top foil 5 and the bearing sleeve 6 so that the roots of the third gaps 5-4 are exactly located at the outer edge of the end of the bearing sleeve 6, and bending the top foil 5 outward along the third gaps 5-4 to form trumpet-shaped diversion ports, thus completing the installation of the foil hydrodynamic bearing for use.
S2: Successively inserting one positioning spacer 2 and turbo impeller 1 from one side of the main shaft 3, wherein the positioning spacer 2 and the main shaft 3 are in transition fit, and the turbo impeller 1 and the main shaft 3 are in interference fit.
S3: Inserting the foil hydrodynamic bearing installed in the above steps from the other side of the main shaft 3, and installing the foil hydrodynamic bearing on the main shaft so that the diversion ports 5-5 face the positioning spacer 2 and the turbo impeller 1, wherein the top foil 5 and the main shaft 3 are in slight interference fit, thus completing the installation of the whole single-sided blow-in foil bearing system with self-pressurization and self-cooling capabilities and obtaining the schematic diagram of the single-sided blow-in foil bearing system with self-pressurization and self-cooling capabilities shown in FIG. 8.

A usage method for a single-sided blow-in foil bearing system with self-pressurization and self-cooling capabilities is as follows:

One turbo impeller 1 is arranged on one side of the foil hydrodynamic bearing, and fluid flows towards the bearing. At this moment, high-speed fluid will enter the clearance between the top foil 5 and the main shaft 3 under the guidance of the trumpet-shaped diversion ports 5-5 of the top foil 5 close to the side with the turbo impeller 1 and then flow out from the other end of the bearing. The hydrostatic pressure generated and the hydrodynamic pressure generated by the bearing due to rotation act together, the main shaft 3 is supported, the compliant support structure 4 is compressed and deformed, and the clearance between the top foil 5 and the main shaft 3 increases accordingly, which enhances the load-carrying capacity and reduces the risk of rub-impact between the main shaft 3 and the top foil 5. Moreover, the working heat flow of the bearing is carried away, finally improving the comprehensive performance of the bearing.

The above embodiments only express the implementation of the present invention, and shall not be interpreted as a limitation to the scope of the present invention. It should be noted that, for those skilled in the art, several variations and improvements can also be made without departing from the concept of the present invention, all of which belong to the protection scope of the present invention.

1. A foil bearing system with self-pressurization and self-cooling capabilities, comprising turbo impellers (1), positioning spacers (2), a main shaft (3), a compliant support structure (4), a top foil (5) and a bearing sleeve (6); specifically:
the edge of each turbo impeller (1) is provided with a plurality of flow-guide vanes (1-1), and when the turbo impeller (1) rotates with the main shaft, the working medium produces a directional flow; and the turbo impeller (1) is provided with a main shaft mounting hole (1-2) in the middle for installing the main shaft (3);
the positioning spacers (2) are in an annular shape, and the positioning spacers (2) are arranged on cylinders at both ends of the main shaft (3) and fitted with the end faces of a middle cylinder of the main shaft (3) for restricting the position of the turbo impeller (1) on the main shaft (3);
the main shaft (3) is a stepped cylinder, comprising the middle cylinder and the end cylinders located at both ends, and has an integrated structure, and the diameter of the end cylinders is smaller than that of the middle cylinder; and the middle cylinder is installed in conjunction with the inner wall surface of the top foil (5), and the end cylinders are installed in conjunction with the main shaft mounting holes (1-2) of the turbo impellers (1) and the positioning spacers (2);
the compliant support structure (4) is a cylindrical thin shell formed by bending a rectangular foil, and after the rectangular foil is bent into the cylindrical thin shell, the boundaries of both sides do not come into contact, forming a first gap (4-1); and the outer wall surface of the compliant support structure (4) is in contact with the inner wall surface of the bearing sleeve (6), and the inner wall surface of the compliant support structure (4) is in contact with the outer wall surface of the top foil (5);
the top foil (5) is a cylindrical thin shell formed by bending a rectangular foil, having smooth and flat wall surfaces; and the cylinder wall of the top foil (5) is provided with a plurality of first diversion holes (5-3) as fluid channels;
the bearing sleeve (6) is cylindrical, with a plurality of second diversion holes (6-2) machined on the wall surface as fluid channels.

2. The foil bearing system with self-pressurization and self-cooling capabilities according to claim 1, wherein in the compliant support structure (4), the cylindrical thin shell is pressed into bump structures (4-2) which are alternately arranged along axial and circumferential directions; and an elastic clearance is formed between the top foil (5) and the bearing sleeve (6) through the bump structures (4-2) as a fluid flow channel.

3. The foil bearing system with self-pressurization and self-cooling capabilities according to claim 1, wherein in the top foil (5), when the rectangular foil are bent into shape, both sides that intersect have an overlap, and the overlap is bent outward to form inclined strip fins (5-1); both ends of the strip fins (5-1) form second gaps (5-2) with the upper and lower boundaries of the cylindrical thin shell along the axis of the cylindrical thin shell, and the width of the second gaps (5-2) is less than that of the first gap (4-1); and a plurality of third gaps (5-4) are machined on both sides or one side of the top foil (5) along the axial direction, and the top foil (5) is bent through the third gaps (5-4) after being assembled into the bearing sleeve (6), forming trumpet-shaped diversion ports (5-5).

4. The foil bearing system with self-pressurization and self-cooling capabilities according to claim 3, wherein the first diversion holes (5-3) and the second gaps (5-2) are opposite in position, that is, differing by 180° along the circumferential direction.

5. The foil bearing system with self-pressurization and self-cooling capabilities according to claim 3, wherein the third gaps (5-4) are machined on both sides or one side of the top foil (5):
if machined on both sides, the third gaps (5-4) are symmetrically arranged at both ends, the length of the gaps on one side is equal to half the difference between the axial length of the top foil (5) and the axial length of the bearing sleeve (6); and if only machined on one side, the length of the gaps is equal to the difference between the axial length of the top foil (5) and the axial length of the bearing sleeve (6).

6. The foil bearing system with self-pressurization and self-cooling capabilities according to claim 1, wherein the inner wall surface of the bearing sleeve (6) is provided with a fourth gap (6-1) for inserting the strip fins (5-1) of the top foil (5); the fourth gap (6-1) is axially penetrating, but cannot penetrate the wall surface of the bearing sleeve (6) in the depth direction; and second diversion holes (6-2) are machined on the wall surface of one side of the fourth gap (6-1) of the bearing sleeve (6).

7. The foil bearing system with self-pressurization and self-cooling capabilities according to claim 1, wherein one or two turbo impellers (1) are provided, and one or two positioning spacers (2) matched with the turbo impellers (1) are provided; and the turbo impellers (1) are installed by interference fit with the end cylinders of the main shaft (3).

8. The foil bearing system with self-pressurization and self-cooling capabilities according to claim 7, wherein in case that one turbo impeller (1) is provided:
when the rotation of the turbo impeller (1) causes fluid to flow towards a clearance between the top foil (5) and the main shaft (3) in the middle, that is, the fluid flows towards the foil bearing in the middle, the foil bearing system is a single-sided blow-in foil bearing system with self-pressurization and self-cooling capabilities;
when the rotation of the turbo impeller (1) causes fluid to flow away from the foil bearing in the middle, the foil bearing system is a single-side suction-type foil bearing system with self-pressurization and self-cooling capabilities.

9. The foil bearing system with self-pressurization and self-cooling capabilities according to claim 7, wherein in case that two turbo impellers (1) are provided:
when the rotation of the turbo impellers (1) on both sides causes fluid to flow towards the foil bearing in the middle, the foil bearing system is a double-sided blow-in foil bearing system with self-pressurization and self-cooling capabilities;
when the rotation of the turbo impellers (1) on both sides causes fluid to flow away from the foil bearing in the middle, the foil bearing system is a double-sided suction-type foil bearing system with self-pressurization and self-cooling capabilities;
when the rotation of the turbo impeller (1) on one side causes fluid to flow towards the foil bearing in the middle, and the rotation of the turbo impeller (1) on the other side causes fluid to flow away from the foil bearing in the middle, the foil bearing system is a double-sided blow-and-suck foil bearing system with self-pressurization and self-cooling capabilities.

10. The foil bearing system with self-pressurization and self-cooling capabilities according to claim 1, wherein the turbo impellers (1) are made of a metal material; the positioning spacers (2) are made of a metal material; the main shaft (3) is made of a metal material; the compliant support structure (4) is made of a metal material; the top foil (5) is made of a metal material; and the bearing sleeve (6) is made of a metal material.
